(19) United States
(12) Patent Application Publication
(10) Pub. No.: US 2019/0295430 A1
(43) Pub. Date: Sep. 26, 2019

(54) METHOD OF REAL-TIME SUPERVISION OF INTERACTIVE ONLINE EDUCATION

(71) Applicant: TUTOR GROUP Limited, Kowloon (HK)

(72) Inventor: Cheng-Ta YANG, Taipei (TW)

(21) Appl. No.: 16/215,815

(22) Filed: Dec. 11, 2018

(30) Foreign Application Priority Data
Mar. 20, 2018 (TW) 107109476

(51) Int. Cl. G09B 5/08; G06K 9/00

(52) U.S. Cl. CPC G09B 5/08; H04L 67/42; G06K 9/00335; G06K 9/00315

(57) ABSTRACT

A method is to be implemented by an online education system, and includes: when it is determined based on image data received from a teacher-end device that an image contains an image portion which corresponds to a body part above a chest of a teacher, determining whether one of a facial expression, a facial movement, a face position, and a body portion between a chin and the chest of the teacher satisfies a predetermined condition by performing image recognition on an image data portion of the image data which corresponds to the image portion; and when a result of the determination is affirmative, transmitting a notification message to the teacher-end device for output of the same by the teacher-end device.

### CROSS-REFERENCE TO RELATED APPLICATION

This application claims priority of Taiwanese Invention Patent Application No. 107109476, filed on Mar. 20, 2018.

### FIELD

The disclosure relates to interactive online education, and more particularly to a method of real-time supervision of interactive online education.

### BACKGROUND

Conventional online education is realized by the Internet, with courses being conducted over the Internet for remote students. However, during a conventional online course, it is usually difficult to make a timely response to an abnormality related to the teaching by a teacher or the learning of the students, so effect of learning may be adversely affected.

### SUMMARY

Therefore, an object of the disclosure is to provide a method of real-time supervision of interactive online education that can alleviate at least one of the drawbacks of the prior art.

According to the disclosure, the method is to be implemented by an online education system. The online education system includes a teacher-end device that displays course material for viewing by a teacher, a student-end device that displays the course material for viewing by a student, and a server that is communicably connected with the teacher-end device and the student-end device via a communication network. The teacher-end device continuously captures an image of a space where the teacher is located to result in image data, and transmits the image data via the communication network to the server in real time so as to enable the server to transmit the image data via the communication network to the student-end device in real time for display of the image by the student-end device. The method includes steps of:

by the server, when it is determined based on the image data received from the teacher-end device that the image contains an image portion which corresponds to a body part above a chest of the teacher, determining whether one of a facial expression, a facial movement, a face position, and a body portion between a chin and the chest of the teacher satisfies a predetermined condition by performing image recognition on an image data portion of the image data which corresponds to the image portion; and

by the server, when it is determined that one of the facial expression, the facial movement, the face position, and the body portion between the chin and the chest of the teacher satisfies the predetermined condition, transmitting a notification message which is associated with the predetermined condition via the communication network to the teacher-end device for output of the notification message by the teacher-end device.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an embodiment of an online education system according to the disclosure;

FIG. 2 is a schematic diagram illustrating an embodiment of a screen image displayed by a teacher-end device of the online education system during a positioning procedure according to the disclosure;

FIG. 3 is a schematic diagram illustrating an embodiment of a screen image displayed by a student-end device of the online education system according to the disclosure, containing a first image and course material;

FIG. 4 is a flowchart illustrating an embodiment of a method of real-time supervision of interactive online education according to the disclosure;

FIG. 5 is a schematic diagram illustrating an embodiment of a screen image displayed by the teacher-end device of the online education system according to the disclosure, showing a pop-up warning message;

FIGS. 6 to 9 are schematic diagrams illustrating embodiments of screen images displayed by the teacher-end device of the online education system according to the disclosure, showing different first notification message; and

FIG. 10 is a schematic diagram illustrating an embodiment of a screen image displayed by the teacher-end device of the online education system according to the disclosure, showing a second notification message.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

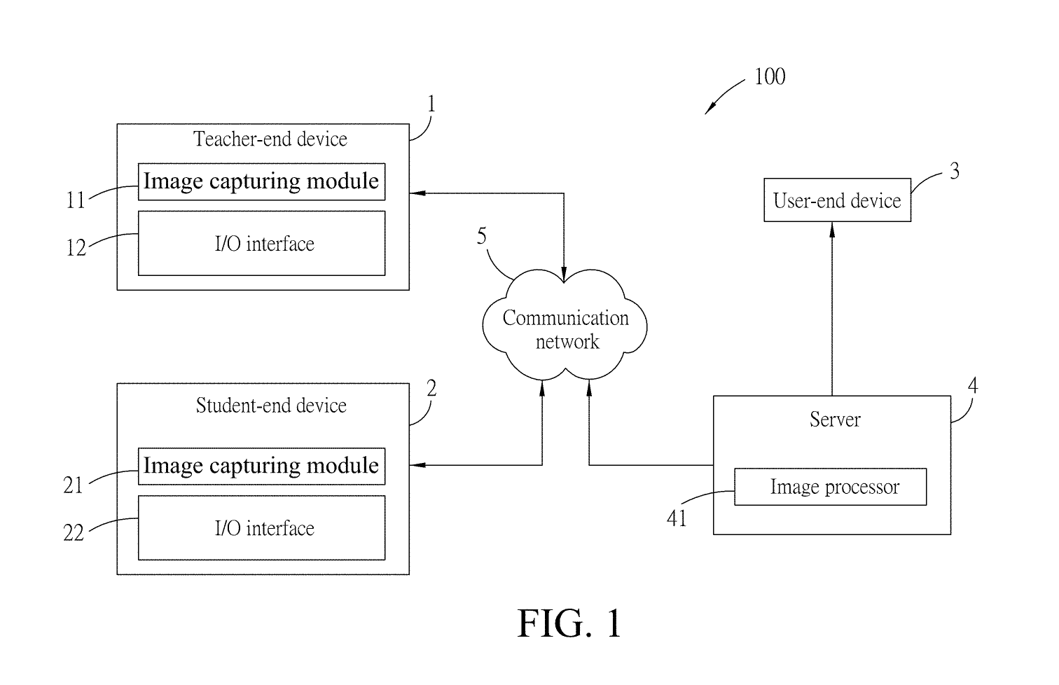

Referring to FIG. 1, an embodiment of an online education system 100 according to the disclosure is illustrated. The online education system 100 is utilized to implement a method of real-time supervision of interactive online education according to the disclosure.

The online education system 100 includes a teacher-end device 1 that displays course material for viewing by a teacher, a student-end device 2 that displays the course material for viewing by a student, a user-end device 3, and a server 4 that is communicably connected with the teacher-end device 1 and the student-end device 2 via a communication network 5 and that is connected to the user-end device 3. It should be noted that implementations of numbers of the teacher-end device 1 and the student-end device 2 are not limited to the disclosure herein, and may vary in other embodiments. For example, in one embodiment, the teacher-end device 1 is plural in number, and the student-end device 2 is also plural in number. The course material may be shared among a teacher and one or more students who participate in a course corresponding to the course material. For the sake of brevity and clarity of explanation, each of the teacher-end device 1 and the student-end device 2 is assumed to be one in number in the following descriptions.

The teacher-end device 1 may be implemented by a personal computer or a notebook computer which includes an image capturing module 11 (e.g., a camera) and an input/output (I/O) interface 12 that may include one or more of a keyboard, a mouse, a display and a speaker. However, implementation of the teacher-end device 1 is not limited to the disclosure herein and may vary in other embodiments.

Similar to the teacher-end device 1, the student-end device 2 may be implemented by a personal computer or a notebook computer which includes an image capturing module 21 (e.g., a camera) and an I/O interface 22 that may include one or more of a keyboard, a mouse, a display and a speaker. However, implementation of the student-end device 2 is not limited to the disclosure herein and may vary in other embodiments.

The user-end device 3 may be implemented by a personal computer or a notebook computer that is set up for supervision, and that is in wired connection with the server 4. However, implementation of the user-end device 3 is not limited to the disclosure herein and may vary in other embodiments. For example, the user-end device 3 may be connected via the communication network 5 or via another communication network (not shown) to the server 4.

The server 4 includes an image processor 41. The server 4 may be implemented to be a network server or a data server, but implementation of the server 4 is not limited to the disclosure herein and may vary in other embodiments.

The teacher-end device 1 is appropriately placed, in advance, in a space where the teacher is expected to be present when conducting the course, with the image capturing module 11 of the teacher-end device 1 being set up to continuously capture an image of the space the teacher is to be present (especially aiming to capture an image of an upper body portion of the teacher). Similarly, the student-end device 2 is appropriately placed, in advance, in a space where the student is expect to be present when learning the course, with the image capturing module 21 of the student-end device 2 being set up to continuously capture an image of the space the student is to be present (especially aiming to capture an image of an upper body portion of the student).

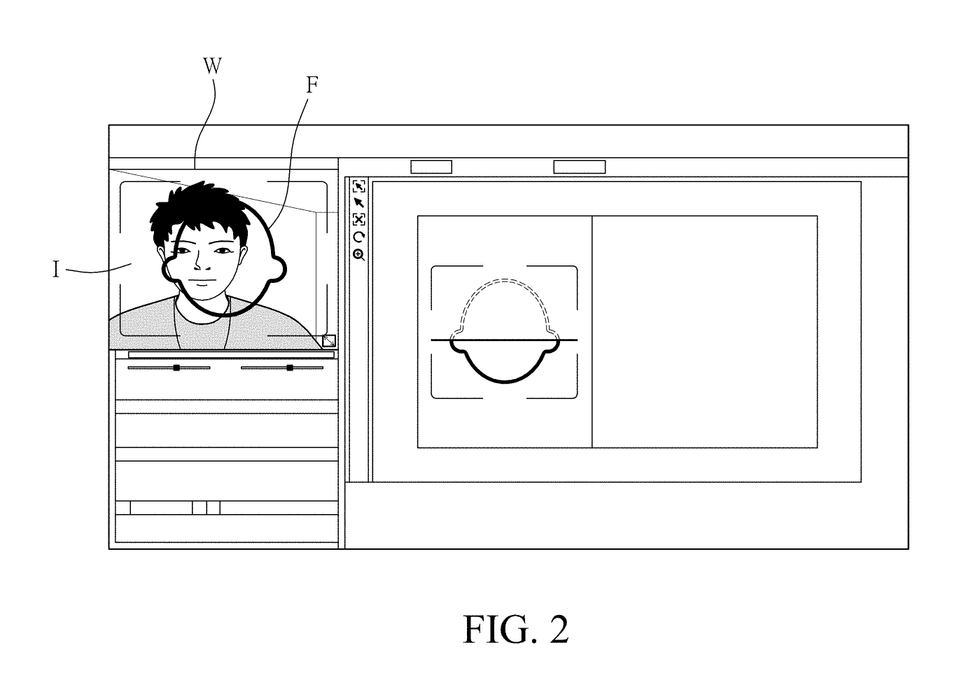

Prior to starting the course, the online education system 100 executes a positioning procedure related to position of the teacher with respect to the image capturing module 11 of the teacher-end device 1. For example, referring to FIG. 2, during the positioning procedure, the image capturing module 11 of the teacher-end device 1 is adjusted to ensure that an image of the teacher (I) captured by the image capturing module 11 is displayed in a teacher-image window (W) on the display of the teacher-end device 1, and a face of the teacher in the image (I) is within a reference positioning frame (F) displayed in the teacher-image window (W) on the display of the teacher-end device 1. In this way, the image capturing module 11 of the teacher-end device 1 is able to clearly capture an image of a body part above the chest of the teacher.

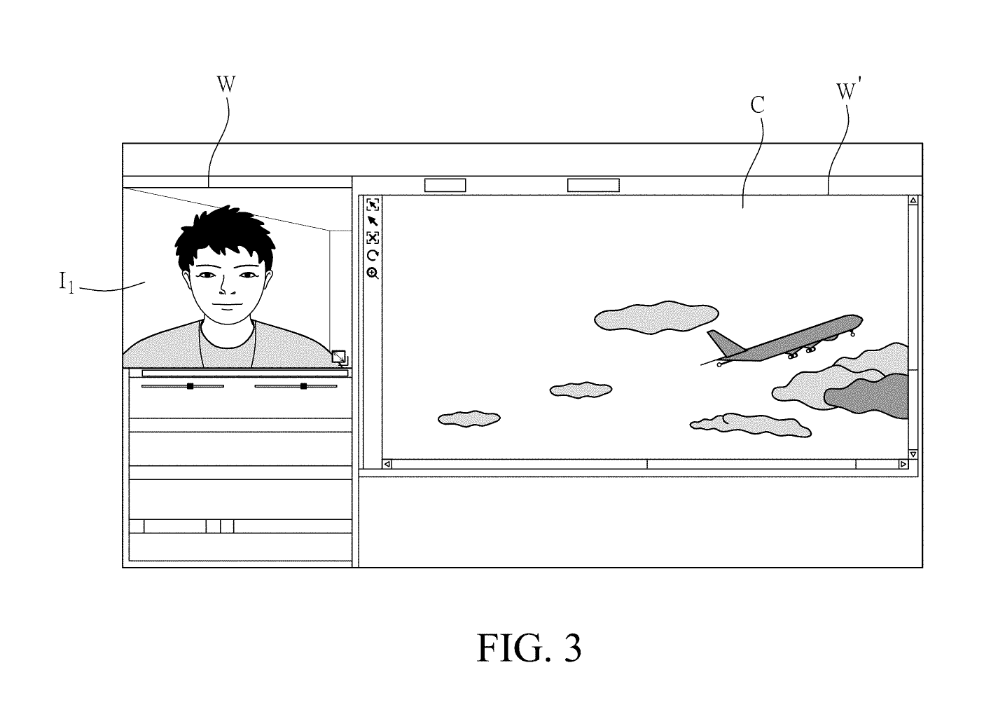

The course material for the course may be downloaded in advance from the server 4 onto the teacher-end device 1 and the student-end device 2, and the course material is displayed on the teacher-end device 1 and the student-end device 2 at the same time throughout a predetermined course period, e.g., from 19:00 to 20:15 on Jan. 31, 2018. In the predetermined course period, the image capturing module 11 of the teacher-end device 1 continuously captures a first image of the space where the teacher is located to result in first image data. Then, the teacher-end device 1 transmits the first image data via the communication network 5 to the server 4 in real time so as to enable the server 4 to transmit the first image data via the communication network 5 to the student-end device 2 in real time for display of the first image by the student-end device 2. When the position of the teacher with respect to the image capturing module 11 of the teacher-end device 1, as adjusted during the positioning procedure, is maintained, the first image, which should contain the body part above the chest of the teacher, is displayed on the display of the student-end device 2, such as an image (I₁) displayed in another teacher-image window (W) as shown in FIG. 3. In addition, the course material can be displayed as another image (C) in a course-material window (W′) on the display of the student-end device 2 as shown in FIG. 3. In other words, the student is able to not only read or watch the course material by the student-end device 2, but also see facial expressions of the teacher through the first image displayed, so as to simulate a scenario of face-to-face teaching. Moreover, the student-end device 2 continuously captures a second image of a space where the student is located which should contain a face of the student to result in second image data, and transmits the second image data via the communication network 5 to the server 4 in real time.

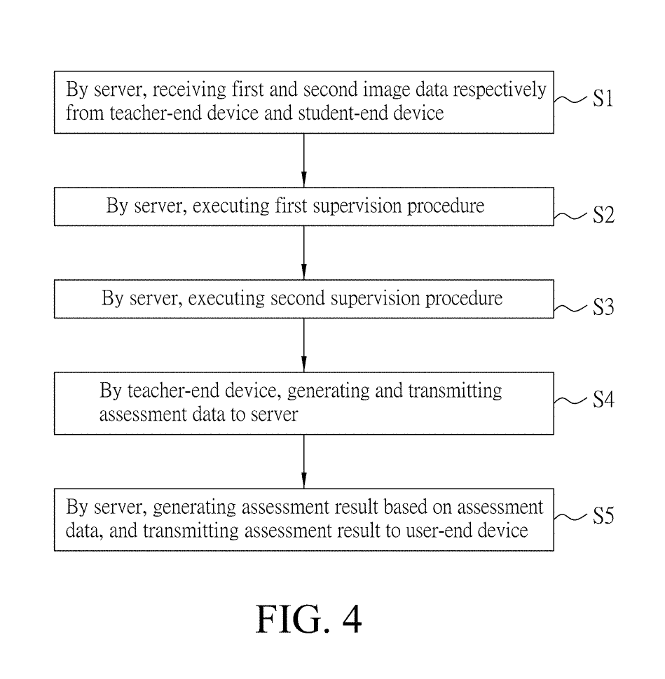

Referring to FIGS. 1 and 4, the method according to the disclosure includes steps S1 to S5 described as follows.

In step S1, the server 4 continuously receives the first image data from the teacher-end device 1 and the second image data from the student-end device 2. Then, a flow of procedure proceeds to step S2.

In step S2, the server 4 executes a first supervision procedure. In the first supervision procedure, based on the first image data received from the teacher-end device 1, the server 4 determines whether the first image contains an image portion which corresponds to the body part above the chest and below a chin of the teacher.

For example, by utilizing facial recognition techniques, a position of the chin of the teacher is initially determined to be a lowest point of the face of the teacher in the image. Thereafter, by utilizing edge detection, a neck, a shoulder and a neckline of clothing of the teacher in the image are traced out. In this way, the server 4 determines whether the first image contains the image portion which corresponds to the body part between the chest and the chin of the teacher.

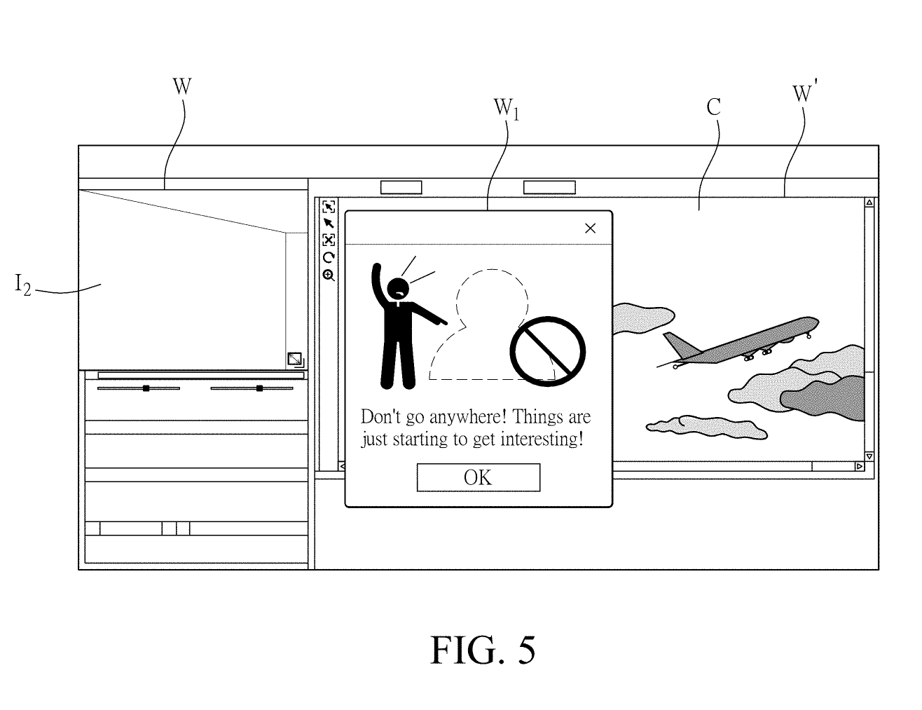

When it is determined that the first image does not contain the image portion, which may be due to that the position of the teacher with respect to the image capturing module 11 of the teacher-end device 1 has changed, the server 4 transmits a warning message via the communication network 5 to the teacher-end device 1 for output of the warning message by the teacher-end device 1. For example, based on an image (I₂), wherein the teacher is absent from a field of view of the image capturing module 11, displayed in the teacher-image window (W) on the display of the teacher-end device 1 as shown in FIG. 5, the server 4 determines that the first image does not contain the image portion, and transmits the warning message to the teacher-end device 1 for displaying the same so as to notify the teacher to restore the appropriate position with respect to the image capturing module 11 of the teacher-end device 1. In this embodiment, the warning message is exemplified as a pop-up message of “Don't go anywhere! Things are just starting to get interesting!” as shown in a first window (W₁) in FIG. 5, but implementation of the warning message is not limited to the disclosure herein and may vary in other embodiments. Although the output of the warning message is exemplified by displaying the warning message, implementation of the output of the warning message is not limited to the disclosure herein and may vary in other embodiments. For example, the output of the warning message may be implemented by playing an audio message (e.g., ringing a warning bell) or an audiovisual message.

On the other hand, when it is determined that the first image contains the image portion, the server 4 determines whether one of a facial expression, a facial movement, a face position, and a body portion between the chin and the chest of the teacher satisfies a first predetermined condition by performing image recognition on an image data portion of the first image data which corresponds to the image portion, using conventional image recognition techniques. In this embodiment, the first predetermined condition includes one of a first sub-condition, a second sub-condition, a third sub-condition, a fourth sub-condition, a fifth sub-condition, a sixth sub-condition, and any combination thereof. However, implementation of the first predetermined condition is not limited to the disclosure herein and may vary in other embodiments. When it is determined that one of the facial expression, the facial movement, the face position, and the body portion between the chin and the chest of the teacher satisfies at least one of the first to sixth sub-conditions, the server 4 determines that said one of the facial expression, the facial movement, the face position, and the body portion between the chin and the chest of the teacher satisfies the first predetermined condition.

When it is determined that one of the facial expression, the facial movement, the face position, and the body portion between the chin and the chest of the teacher satisfies the first predetermined condition, the server 4 transmits a first notification message which is associated with the first predetermined condition via the communication network 5 to the teacher-end device 1 for output of the first notification message by the teacher-end device 1. At the same time, when it is determined that one of the facial expression, the facial movement, the face position, and the body portion between the chin and the chest of the teacher satisfies the first predetermined condition, the server 4 generates a supervision message (not shown) which indicates identity of the teacher and what satisfies the first predetermined condition, and transmits the supervision message to the user-end device 3 for output of the supervision message by the user-end device 3. In this embodiment, the supervision message indicates a name of the teacher and at least one of the first to sixth sub-conditions that has been satisfied. In this embodiment, each of the outputs of the first notification message and the supervision message is implemented by displaying the same, but implementation of said each of the outputs of the first notification message and the supervision message is not limited to the disclosure herein and may vary in other embodiments. For example, said each of the outputs of the first notification message and the supervision message may be implemented by playing an audio message (e.g., ringing a supervision bell or a first notification bell) or an audiovisual message.

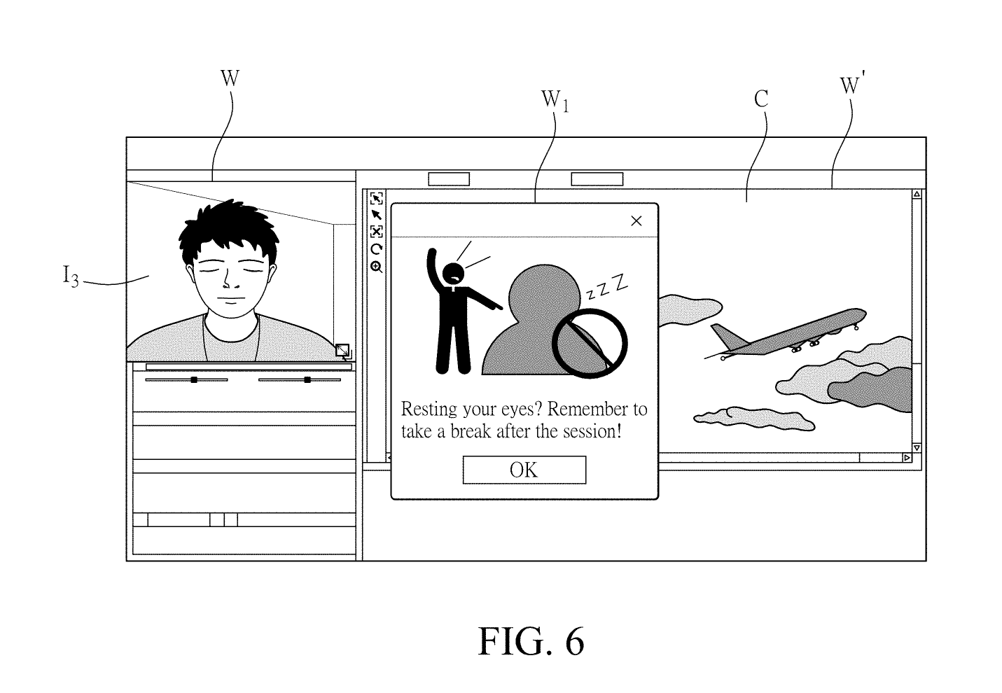

Referring to FIGS. 6 to 9, exemplifications of the first notification message displayed by the teacher-end device 1 corresponding to the first to sixth sub-conditions are described as follows.

Referring to FIG. 6, the first sub-condition is that the eyes of the teacher have been closed for a predetermined teacher eye-closure duration, in which case the facial expression of the teacher relates to eye movements of the teacher. In this embodiment, the predetermined teacher eye-closure duration is three seconds, but implementation thereof is not limited to the disclosure herein and may vary in other embodiments. Specifically speaking, when it is determined that the eyes of the teacher have been closed for the predetermined teacher eye-closure duration based on the first image, such as an image (I₃), wherein the eyes of the teacher are closed, displayed in the teacher-image window (W) on the display of the teacher-end device 1 as shown in FIG. 6, the server 4 transmits the first notification message that corresponds to the first sub-condition to the teacher-end device 1 for displaying the first notification message, such as “Resting your eyes? Remember to take a break after the session!”, so as to notify the teacher to open his/her eyes. In this embodiment, for each eye of the teacher, the server 4 determines whether the eye is closed based on a ratio between a greatest distance between upper and lower eyelids of the eye and a distance between inner and outer canthi of the eye, where the greatest distance between the upper and lower eyelids and the distance between the inner and outer canthi are calculated based on characteristic points located adjacent to the upper and lower eyelids and to the inner and outer canthi of the teacher in the first image. It should be noted that implementation of determining whether the eyes of the teacher are closed is not limited to the disclosure herein and may vary in other embodiments.

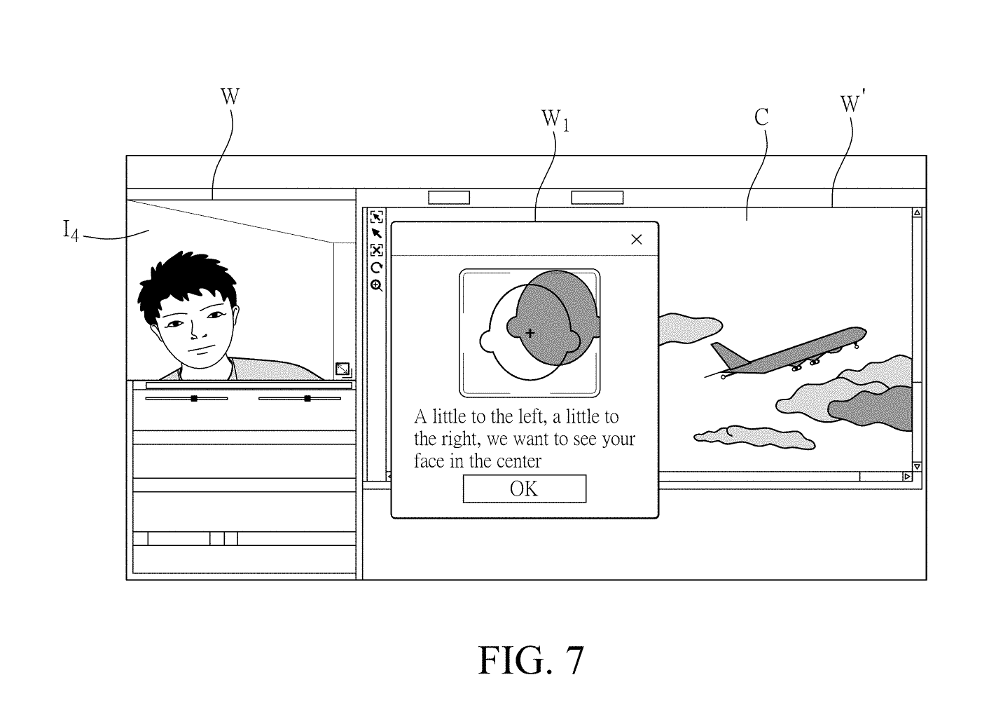

Referring to FIG. 7, the second sub-condition is that the face position of the teacher has been outside a predetermined range for a predetermined teacher face-deviation duration. In this embodiment, the predetermined range is an area enclosed by the reference positioning frame (F) as shown in FIG. 2, and the predetermined teacher face-deviation duration is three seconds. However, implementations of the predetermined range and the predetermined teacher face-deviation duration are not limited to the disclosure herein and may vary in other embodiments. Specifically speaking, when it is determined that the face position of the teacher has been outside the predetermined range for the predetermined teacher face-deviation duration based on the first image, such as an image (I₄), wherein the face position of the teacher is outside the predetermined range, displayed in the teacher-image window (W) on the display of the teacher-end device 1 as shown in FIG. 7, the server 4 transmits the first notification message that corresponds to the second sub-condition to the teacher-end device 1 for displaying the first notification message, such as “A little to the left, a little to the right, we want to see your face in the center!”, so as to notify the teacher to adjust the position of his/her face.

The third sub-condition is that the mouth of the teacher has opened to yawn for a predetermined teacher yawning duration, in which case the facial expression of the teacher relates to mouth movements of the teacher. In this embodiment, the predetermined teacher yawning duration is one second, but implementation of the predetermined teacher yawning duration is not limited to the disclosure herein and may vary in other embodiments. In this embodiment, the server 4 determines whether the mouth of the teacher has opened to yawn based on a ratio between a greatest distance between upper and lower lips of the teacher and a distance between both corners of the mouth of the teacher, where the greatest distance between the upper and lower lips and the distance between the corners of the mouth are calculated based on characteristic points located adjacent to the upper and lower lips and the corners of the mouth of the teacher in the first image. It should be noted that implementation of determining whether the mouth of the teacher has opened to yawn is not limited to the disclosure herein and may vary in other embodiments.

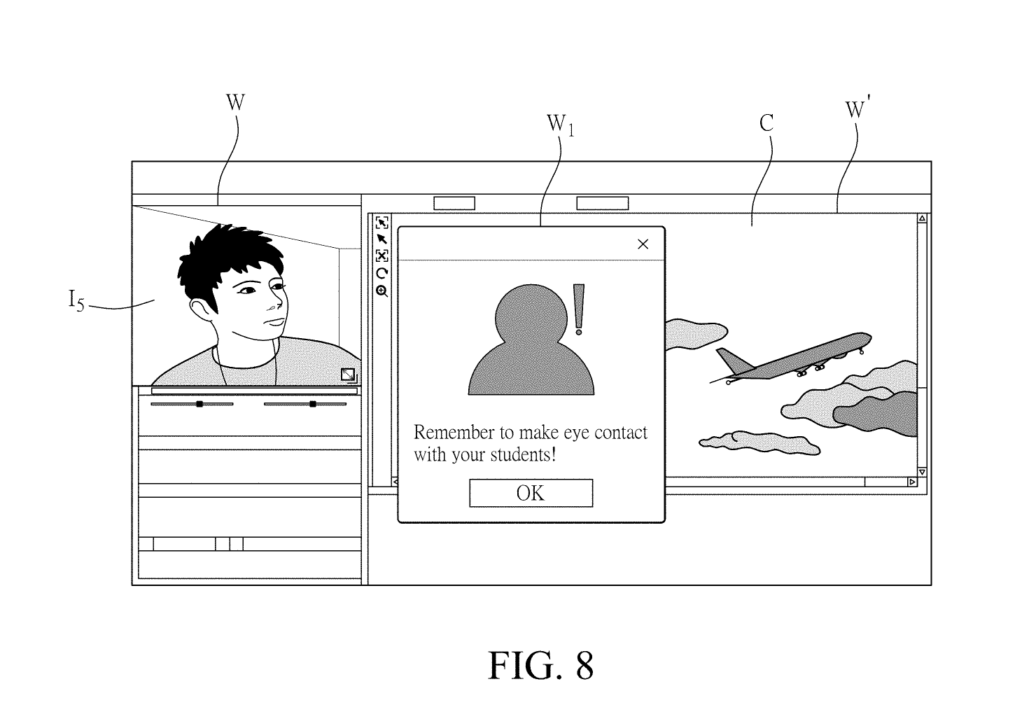

Referring to FIG. 8, in this embodiment, the fourth sub-condition is that the head of the teacher has turned aside for a predetermined teacher head-turning duration. In this embodiment, the predetermined teacher head-turning duration is three seconds, but implementation of the predetermined teacher head-turning duration is not limited to the disclosure herein and may vary in other embodiments. Specifically speaking, when it is determined that the head of the teacher has turned aside for the predetermined teacher head-turning duration based on the first image, such as an image (I₅), wherein the head of the teacher is turned aside, displayed in the teacher-image window (W) on the display of the teacher-end device 1 as shown in FIG. 7, the server 4 transmits the first notification message that corresponds to the fourth sub-condition to the teacher-end device 1 for displaying the first notification message, such as “Remember to make eye contact with your students!”, so as to notify the teacher to return to the normal head position. In this embodiment, the server 4 determines whether the head of the teacher has turned aside for the predetermined teacher head-turning duration based on whether a rolling angle of the face is greater than a predetermined rolling angle (e.g., twenty-six degrees), whether a yaw angle of the face is greater than a predetermined yaw angle (e.g., thirty-three degrees), or whether a pitch angle of the face is greater than a predetermined pitch angle (e.g., ten degrees), where the rolling angle of the face, the yaw angle of the face and the pitch angle of the face are calculated based on characteristic points located on the face of the teacher in the first image.

In this embodiment, the fifth sub-condition is that a ratio of an exposed skin area to a total area of the body portion between the chin and the chest of the teacher is greater than a predetermined skin-exposure ratio. In this embodiment, the exposed skin area is a portion of the area of the body portion between the chin and the chest, and a color of the portion of the area is similar to a color of the face. In this embodiment, the predetermined skin-exposure ratio is 70%, but implementation of the predetermined skin-exposure ratio is not limited to the disclosure herein and may vary in other embodiments. Specifically speaking, when it is determined that the ratio of the exposed skin area to the total area of the body portion between the chin and the chest of the teacher is greater than the predetermined skin-exposure ratio based on the first image, the server 4 transmits the first notification message that corresponds to the fifth sub-condition to the teacher-end device 1 for displaying the first notification message, such as “Please confirm your attire”, so as to notify the teacher to dress properly.

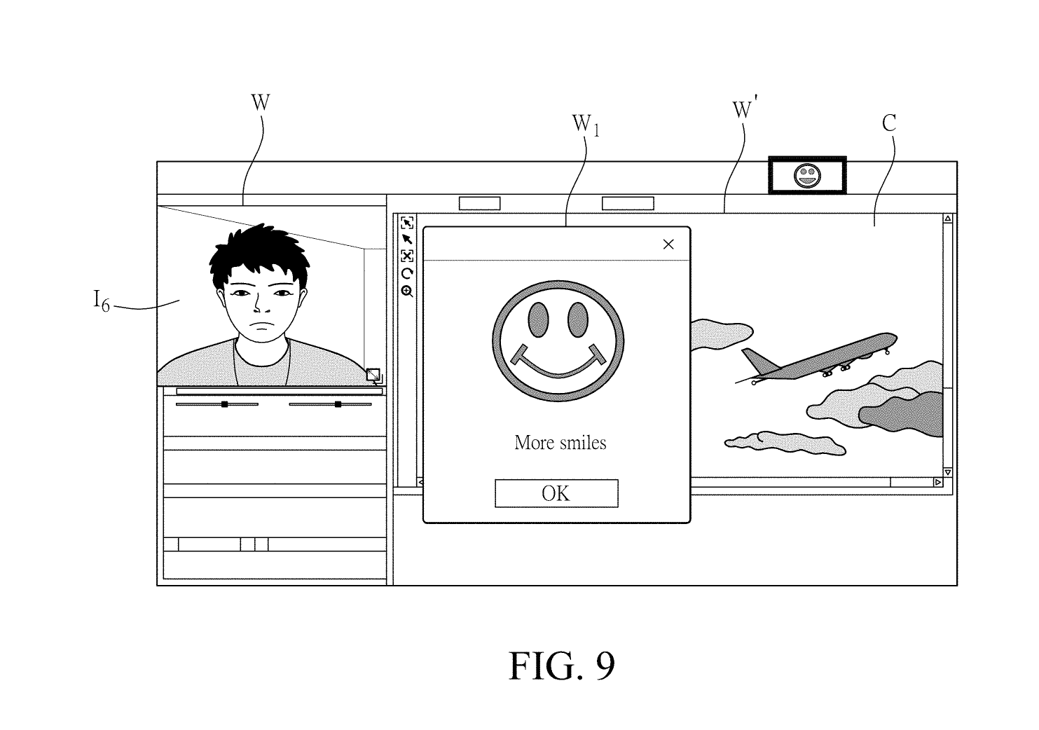

Referring to FIG. 9, in this embodiment, the sixth sub-condition is that the teacher has not smiled for a predetermined teacher no-smile duration. In this embodiment, the predetermined teacher no-smile duration is sixty seconds, but implementation of the predetermined teacher no-smile duration is not limited to the disclosure herein and may vary in other embodiments. Specifically speaking, when it is determined that the teacher has not smiled for the predetermined teacher no-smile duration based on the first image, such as an image (I₆), wherein the teacher is not smiling, displayed in the teacher-end window (W) on the display of the teacher-end device 1 as shown in FIG. 9, the server 4 transmits the first notification message that corresponds to the sixth sub-condition to the teacher-end device 1 for displaying the first notification message, such as “More smiles”, so as to notify the teacher to be more approachable. In this embodiment, the server 4 determines whether the teacher is smiling based on a curve formed by characteristic points located around the mouth. When it is determined that the curve is concave upward for more than one second, the server 4 determines that the teacher is smiling.

Referring back to FIG. 4, in step S3, the server 4 executes a second supervision procedure. In the second supervision procedure, based on the second image data received from the student-end device 2, the server 4 determines whether one of the facial expression and the facial movement of the student satisfies a second predetermined condition by performing image recognition techniques. In this embodiment, the second predetermined condition includes one of a seventh sub-condition, an eighth sub-condition, a ninth sub-condition, and any combination thereof. However, implementation of the second predetermined condition is not limited to the disclosure herein and may vary in other embodiments. When it is determined that one of the facial expression and the facial movement of the student satisfies at least one of the seventh to ninth sub-conditions, the server 4 determines that said one of the facial expression and the facial movement of the student satisfies the second predetermined condition.

When it is determined that one of the facial expression and the facial movement of the student satisfies the second predetermined condition, the server 4 transmits the second image data and a second notification message which is associated with the second predetermined condition via the communication network 5 to the teacher-end device 1 for output of the second image and the second notification message at the same time by the teacher-end device 1. In this embodiment, the output of the second notification message is implemented by displaying the same, but implementation of the output of the second notification message is not limited to the disclosure herein and may vary in other embodiments. For example, the output of the second notification message may be implemented by playing an audio message (e.g., ringing a second notification bell) or an audiovisual message.

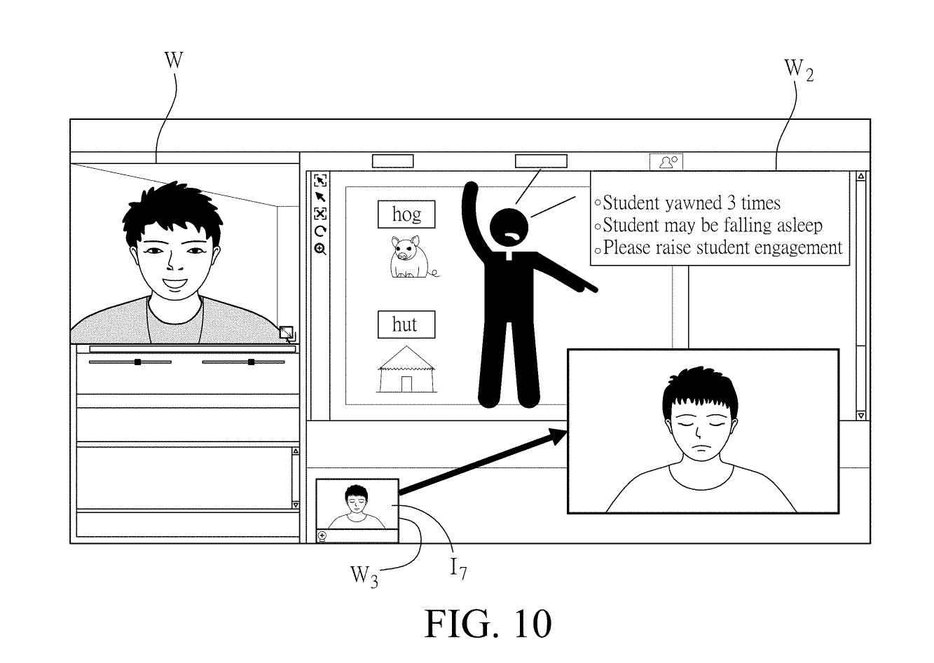

Referring to FIG. 10, exemplifications of the second notification message displayed by the teacher-end device 1 corresponding to the seventh to ninth sub-conditions are described as follows.

In this embodiment, the seventh sub-condition is that the eyes of the student have been closed for a predetermined student eyes-closure duration, in which case the facial expression of the student relates to eye movements of the student. In this embodiment, the predetermined student eyes-closure duration and the predetermined teacher eyes-closure duration are identical, but implementation of the predetermined student eyes-closure duration is not limited to the disclosure herein and may vary in other embodiments.

In this embodiment, the eighth sub-condition is that the mouth of the student has opened to yawn for a predetermined student yawning duration, in which case the facial expression of the student relates to mouth movements of the student. In this embodiment, the predetermined student yawning duration and the predetermined teacher yawning duration are identical, but implementation of the predetermined student yawning duration is not limited to the disclosure herein and may vary in other embodiments. As shown in FIG. 10, when it is determined that the mouth of the student has opened to yawn for the predetermined student yawning duration based on the second image data, the server 4 transmits the second notification message that corresponds to the eighth sub-condition to the teacher-end device 1 for displaying the second notification message, including, for example, “Student yawned 3 times”, “Student may be falling asleep” and “Please raise student engagement” that are displayed in a second window (W₂), and transmits the second image data to the teacher-end device 1 for displaying the second image as an image (I₇) in a third window (W₃), so as to notify the teacher to try to catch the attention of the student.

In this embodiment, the ninth sub-condition is that the student has not smiled for a predetermined student no-smile duration. In this embodiment, the predetermined student no-smile duration and the predetermined teacher no-smile duration are identical, but implementation of the predetermined student no-smile duration is not limited to the disclosure herein and may vary in other embodiments.

It should be noted that implementation of the order of executions of steps S2 and S3 is not limited to the disclosure herein, and may vary in other embodiments. For example, step S3 may be executed prior to S2 in some embodiments.

Furthermore, in step S3 when the server 4 is executing the second supervision procedure, the server 4 counts a cumulative number of times said one of the facial expression and the facial movement of the student satisfies the second predetermined condition in the predetermined course period. For example, the cumulative number of times the eyes of the student have been closed may be counted as two, and the cumulative number of times the mouth of the student has opened to yawn may be counted as one.

In step S4, at the end of the predetermined course period, the teacher-end device 1, based on user operation, generates assessment data that is associated with performance of the student during the predetermined course period and that includes an assessment score. Subsequently, the teacher-end device 1 transmits the assessment data to the server 4, and the server 4 receives the assessment data. Thereafter, a flow of procedure proceeds to step S5. In this embodiment, the user operation is an operation by the teacher, and the assessment score is given by the teacher based on his/her observation of the performance of the student during the predetermined course period. The better the performance of the student, the higher the assessment score. The assessment score may be exemplified as 8.0.

In step S5, when receiving the assessment data from the teacher-end device 1, the server 4 generates an assessment result that relates to the performance of the student during the predetermined course period and that indicates what (i.e., which behavior of the student) satisfies the second predetermined condition, the cumulative number of times, and the assessment score in the predetermined course period. Thereafter, the server 4 transmits the assessment result to the user-end device 3 for display of the assessment result by the user-end device 3. Following the example previously described, the assessment result indicates that the cumulative number of times the eyes of the student have been closed is two, that the cumulative number of times the mouth of the student has opened to yawn is one, and that the assessment score is 8.0. The user-end device 3 may further make a determination based on the assessment result. For example, in a scenario that the online education system 100 is utilized by a commercial education company, the user-end device 3 may determine whether the assessed student is likely to ask for a refund due to an unsuitable or unsatisfactory course. When the determination is affirmative, managers of the commercial education company may respond by approaching the assessed student and showing concern, in order to improve the quality of the course.

It is worth noting that in one embodiment, the online education system 100 may be utilized by a plurality of courses that are being conducted at the same time. For each of the courses, the corresponding teacher-end device 1, said one or more corresponding student-end devices 2, the user-end device 3 and the server 4 are utilized, and the server 4 executes the first supervision procedure on the first image data received from the teacher-end device 1 and the second supervision procedure on the second image data received from each student-end device 2.

In summary, when it is determined that one of the facial expression, the facial movement, the face position, and the body portion between the chin and the chest of the teacher satisfies the first predetermined condition, or that one of the facial expression and the facial movement of the student satisfies the second predetermined condition, the server 4 transmits the first notification message or the second notification message to the teacher-end device 1 for display of the first notification message or the second notification message. Informed by the first notification message or the second notification message, the teacher may be able to respond in time, improving quality of a course and effectiveness of teaching and learning.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of real-time supervision of interactive online education, the method to be implemented by an online education system, the online education system including a teacher-end device that displays course material for viewing by a teacher, a student-end device that displays the course material for viewing by a student, and a server that is communicably connected with the teacher-end device and the student-end device via a communication network, the teacher-end device continuously capturing a first image of a space where the teacher is located to result in first image data, and transmitting the first image data via the communication network to the server in real time so as to enable the server to transmit the first image data via the communication network to the student-end device in real time for display of the first image by the student-end device, the method comprising:
by the server, when it is determined based on the first image data received from the teacher-end device that the first image contains an image portion which corresponds to a body part above a chest of the teacher, determining whether one of a facial expression, a facial movement, a face position, and a body portion between a chin and the chest of the teacher satisfies a first predetermined condition by performing image recognition on an image data portion of the first image data which corresponds to the image portion; and
by the server, when it is determined that one of the facial expression, the facial movement, the face position, and the body portion between the chin and the chest of the teacher satisfies the first predetermined condition, transmitting a first notification message which is associated with the first predetermined condition via the communication network to the teacher-end device for output of the first notification message by the teacher-end device.

2. The method as claimed in claim 1, wherein:
the first predetermined condition includes one of a first sub-condition, a second sub-condition, a third sub-condition, a fourth sub-condition, a fifth sub-condition, a sixth sub-condition, and any combination thereof;
the first sub-condition is that eyes of the teacher have been closed for a predetermined teacher eye-closure duration;
the second sub-condition is that the face position of the teacher has been outside a predetermined range for a predetermined teacher face-deviation duration;
the third sub-condition is that a mouth of the teacher has opened to yawn for a predetermined teacher yawning duration;
the fourth sub-condition is that a head of the teacher has turned aside for a predetermined teacher head-turning duration;
the fifth sub-condition is that a ratio of an exposed skin area to a total area of the body portion between the chin and the chest of the teacher is greater than a predetermined skin-exposure ratio; and
the sixth sub-condition is that the teacher has not smiled for a predetermined teacher no-smile duration.

3. The method as claimed in claim 1, further comprising:
by the server, when it is determined based on the first image data that the first image does not contain the image portion, transmitting a warning message via the communication network to the teacher-end device for output of the warning message by the teacher-end device.

4. The method as claimed in claim 1, further comprising:
by the student-end device, continuously capturing a second image of a face of the student to result in second image data, and transmitting the second image data via the communication network to the server in real time;
by the server, based on the second image data received from the student-end device, determining whether one of a facial expression and a facial movement of the student satisfies a second predetermined condition by performing image recognition; and
by the server, when it is determined that one of the facial expression and the facial movement of the student satisfies the second predetermined condition, transmitting a second notification message which is associated with the second predetermined condition via the communication network to the teacher-end device for output of the second notification message by the teacher-end device.

5. The method as claimed in claim 4, further comprising:
by the server, when it is determined that one of the facial expression and the facial movement of the student satisfies the second predetermined condition, further transmitting the second image data via the communication network to the teacher-end device for output of the second image and the second notification message at the same time by the teacher-end device.

6. The method as claimed in claim 5, wherein:
the second predetermined condition includes one of a seventh sub-condition, an eighth sub-condition, a ninth sub-condition, and any combination thereof;
the seventh sub-condition is that eyes of the student have been closed for a predetermined student eyes-closure duration;
the eighth sub-condition is that a mouth of the student has opened to yawn for a predetermined student yawning duration; and
the ninth sub-condition is that the student has not smiled for a predetermined student no-smile duration.

7. The method as claimed in claim 4, the online education system further including a user-end device connected to the server, the method further comprising:
by the server, when it is determined that one of the facial expression, the facial movement, the face position, and the body portion between the chin and the chest of the teacher satisfies the first predetermined condition, generating a supervision message which indicates an identity of the teacher and what satisfies the first predetermined condition, and transmitting the supervision message to the user-end device for output of the supervision message by the user-end device.

8. The method as claimed in claim 7, further comprising:
by the server, in a predetermined course period when the teacher-end device and the student-end device are displaying the course material, counting a cumulative number of times said one of the facial expression and the facial movement of the student satisfies the second predetermined condition;
by the teacher-end device, generating, based on a user operation, assessment data that relates to performance of the student in the predetermined course period and that includes an assessment score, and transmitting the assessment data to the server; and
by the server, when receiving the assessment data from the teacher-end device, generating an assessment result that relates to the performance of the student in the predetermined course period and that indicates what satisfies the second predetermined condition, the cumulative number of times and the assessment score in the predetermined course period, and transmitting the assessment result to the user-end device for output of the assessment result by the user-end device.
